(19) United States
(12) Patent Application Publication
(10) Pub. No.: US 2010/0061899 A1
(43) Pub. Date: Mar. 11, 2010

(54) FILTERING MEDIUM FOR THE EXHAUST GAS FILTRATION DEVICE OF A DIESEL ENGINE, FILTRATION DEVICE IMPLEMENTING SUCH MEDIUM, AND EXHAUST GAS LINE OF AN INTERNAL COMBUSTION ENGINE IMPLEMENTING SUCH DEVICE

(75) Inventors: Jean-Claude Fayard, Lyon (FR); Jean-Pierre Joulin, Grabels (FR)

Correspondence Address: HESLIN ROTHENBERG FARLEY & MESITI PC, 5 COLUMBIA CIRCLE, ALBANY, NY, 12203, US

(73) Assignees: Jean-Claude Fayard, Lyon (FR); EXOCLEAN FILTRATION TECHNOLOGY, Salindres (FR)

(21) Appl. No.: 12/518,734

(22) PCT Filed: Dec. 5, 2007
(86) PCT No.: PCT/FR07/52441

§ 371 Date: Jun. 11, 2009

(30) Foreign Application Priority Data
Dec. 13, 2006 (FR) 0655496

(51) Int. Cl. B01D 50/00; B01D 53/94; B01D 46/00

(52) U.S. Cl. 422/169; 55/482; 55/482.1

(57) ABSTRACT

A filtration device comprises a plurality of filtering units including a filtering medium. The filtering units are separated from each other by a ceramic mat or cloth coated with a ceramic glue, in order to secure the units to each other while keeping them mechanically and thermally independent. The units are then inserted into a structure, particularly a metallic or ceramic structure, and are secured thereto by a holder, also made of a ceramic mat or cloth coated with a ceramic glue.

### FIELD OF THE INVENTION

The present invention relates in a general way to the field of particle filters, and more particularly, to an exhaust gas filtration device for a diesel engine.

More particularly, the present invention relates to the employment and construction of a novel filtering medium, for inclusion in an exhaust gas filtration device of a diesel engine.

### PRIOR ART

Reducing the pollutant emissions produced by internal combustion engines, and particularly by diesel engines, is an objective set by the public authorities. To this end, the introduction of ever more draconian standards is forcing car makers to develop engines with ever smaller and above all optimized consumption in order to restrict the release of unburnt particles; but also exhaust gas filtration devices so that polluting particles can be retained.

Thus, to reduce the emission of unburnt gaseous pollutants and solid particles, car makers have developed catalytic converters or catalysts, generally comprising a stainless steel casing, a heat insulator and a honeycomb holder impregnated with precious metals, such as platinum or rhodium.

These catalytic converters now comprise a particle filter, whereof the function is to retain the carbon particles, constituting the unburnt particles emitted by the engine. However, one of the difficulties lies in finding solutions so that these carbon particles trapped on the filter are able to burn or to oxidize as they are deposited in order to prevent it from becoming clogged.

Diesel engine particle filter techniques now in use or in the process of development are all faced with the major problem of the incomplete and untimely combustion of the particles retained on the filtering medium. Indeed for conditions of urban use, the exhaust gas temperature reached is insufficient to cause said combustion and to significantly restrict the clogging of the filter.

Without chemical help, the carbon articles produced by the combustion of the diesel only start to oxidize significantly above 500° C. Since such temperatures are practically never reached in urban driving conditions, it is therefore necessary to resort to a chemical process to eliminate them.

In the absence of chemical help, the filter then clogs up which, apart from the fact that it causes the engine to lose pressure, and thereby malfunction, provokes violent reactions when these carbon particles trapped in an excessive concentration flare up suddenly on the filtering medium. This very rapid and very exothermic combustion reaction of a great volume of particles causes very high temperatures locally and generally leads to the filter being destroyed by thermal shock.

To ensure the oxidation of these particles, there is a plurality of systems already in use. Some systems thus propose placing, upstream of the particle filter, an oxidation catalysis means allowing the nitrogen monoxide NO, contained in the exhaust gases, to be converted to nitrogen dioxide NO₂ from 250° C. This technique, known as “Continuous Regenerating Trap” (C.R.T.), combines the effects of the particle filter and the NO oxidation catalyst.

Said means comprises a catalytic holder to which the catalyst is secured, which is generally a precious metal such as platinum or rhodium. The NO₂ produced by the action thereof possesses the property of oxidizing the carbon particles above 250° C. However, the proper operation of the filter depends on the average mean temperature reached and on the ratio of particles emitted relative to the NO₂ formed.

There is a similar means in existence that constitutes an alternative to the latter, wherein said catalyst is secured directly to the particle filter.

Other regeneration techniques resort to the use of organometallic additives added to the diesel, such as cerium, iron, strontium, calcium or the like, so as to coat the carbon particles formed with the metal oxide from the catalyst thereby obtaining an oxidation thereof at a lower temperature.

Said techniques can be used to obtain an effect similar to that obtained with the NO₂ by catalyzing the combustion of the carbonaceous materials at temperatures close to 300, 350° C.

Other techniques involve the employment of additional heating means such as burners, electrical resistances or the like. These additional heating means are only activated when the cartridge shows some initial clogging, revealed by an increase in pressure loss. A regeneration device of this kind is used with the engine running, in other words in the presence of a significant exhaust gas flow. It therefore requires significant heating power in order to simultaneously bring the exhaust gases and the filtering cartridge mass to the right temperature.

Today, most filters comprise a filtering medium made of cordierite in honeycomb form. Cordierite is a ceramic which has low thermal conductivity associated with average mechanical properties, and which is therefore highly sensitive to the abrupt variations in temperature which accompany uncontrolled regenerations.

Indeed, when the phenomenon occurs, this combustion is not at all homogeneous and it is quite possible to see one part of the filter relatively cold and to note, on the part where combustion has broken out, a relatively high temperature. The differences in temperature observed between these hot parts and the rest of the filter due to the low thermal conductivity of the cordierite and despite its low coefficient of expansion, may generate variations in expansion such that hairline cracks may appear, which may in the long run lead to the filtering medium being destroyed.

Cordierite also has another restricting factor, indirectly related to its low thermal conductivity. Indeed the combustion of the carbon in air leads to temperatures above 1,500° C. and there is nothing to prevent these temperatures from being reached if the carbon is present in sufficient concentration. The melting point of cordierite of about 1,400° C. may well be exceeded and the filter destroyed.

To overcome these drawbacks, it is proposed to replace cordierite with silicon carbide. This is increasingly used in manufacturing ceramic filtering medium, but in segmented form.

Silicon carbide has much better thermal conductivity (0.08 cal/cm/s/° C. as against 0.0025 for cordierite), associated with far superior mechanical properties and a melting point above 2,000° C. It therefore affords better resistance to this phenomenon of uncontrolled combustion without however being able to eliminate all incidents. Indeed the weak point of silicon carbide is its high coefficient of expansion, (4.5.10⁻⁶ as against 1.10⁻⁶ for cordierite). Consequently, it does not therefore stand up as well to thermal shocks as cordierite.

To reduce the consequences of this drawback, filtering media made of silicon carbide are manufactured in segmented form and come in the form of mini-blocks generally of square cross-section, bonded to each other by a cement. The function of this cement is to absorb the dimensional differences during the combustion phases related to the high variations in temperature which may be observed. To make this filtering medium mechanically resistant without the constituent segments thereof being able to become dissociated during the combustion phases, it is machined and rotated to make it into shapes of cylindrical revolution or oblong which are then forcibly incorporated into a metal casing surrounded by a ceramic mat, said metal casing being intended to keep the different segments assembled together.

In such a technical context, the objective of the present invention irrespective of the regeneration methods used, is to propose a novel technique for manufacturing and assembling the filtering medium, suitable for very substantially reducing the thermal and mechanical constraints during sudden combustions of the carbon particles deposited (with no drawbacks), so as to eliminate any cracks that may result.

Another objective of the invention is to provide a mode of assembly that allows sudden regenerations, and therefore significant variations in the temperature with no destructive effect on the filter, both with filtering media made of silicon carbide and cordierite or other ceramics that can be used for said function.

Another objective of the invention is to offer the possibility of having parallelepiped shapes instead of the usual cylindrical shapes or revolutions, in order to be able to make extra-flat filtering media.

Another objective of this invention is to have the possibility of directly incorporating in the filtering medium electrical resistances that may make it possible to get rid of all the common regeneration methods in use.

### DISCLOSURE OF THE INVENTION

These objectives, among others, are met by the present invention. This relates first of all to an exhaust gas filtration device including at least one set of filtering units separated from each other by a ceramic mat or cloth coated on its two faces with a ceramic glue, in order to secure them to each other while keeping them mechanically and thermally independent. These filtering units are then inserted into a metallic or ceramic structure or the like. One or more filtering units are therefore able to be inserted into this structure to form more or less substantial assemblies depending on the use envisaged. One or more filtering units are associated in these structures in the same way, with each filtering unit being bonded to a ceramic holder which separates it from its neighbour or from the structure in which it is contained.

According to one preferred inventive embodiment, the filtering units come in the form of a parallelepiped with a honeycomb structure and are of square cross-section, with the side dimension thereof being between 20 and 200 millimetres, for lengths of between 50 and over 500 mm.

According to one remarkable inventive feature, said square cross-sectioned filtering units are mounted directly into the structure containing them, by assembling as required all the following constituents: filtering units, mat coated with a ceramic glue, for example by the method described below.

The container or casing, containing the filtering units, may be made in two parts. It is coated with ceramic glue at each corner. It receives a flexible ceramic holder pre-cut to the right size, said holder having been previously pre-impregnated with water in such a way that the glue is actually able to distribute itself throughout the operation. Simultaneously all the filtering units that it is planned to assemble after being themselves pre-impregnated with water, are amply coated with ceramic glue. Putting the assembly together thus continues by placing the filtering units pre-coated with glue on the ceramic holder, each filtering unit being separated from its neighbour or neighbours or from said container or said casing by the ceramic holder as per the same procedure.

To advantage, the ceramic holder comprises a long fibre based mat or cloth with a density of between 150 and 500 kg/m³; it has a thickness of between 0.5 and 15 mm, depending on the type of use envisaged for the filter and on the size of each filtering unit. The choice of final thickness depends on the level of thermal and mechanical insulation required for the use targeted and on the geometry of the part for absorbing the variations in expansion.

The glue employed is preferably based on oxides or ceramic carbides, generally used for bonding brick or fireproof insulation felt of class 26 or above 1,400° C. which has a coefficient of expansion close to that of the filtering medium used.

To advantage, the filtering units are each associated with an electrical heating resistance (8), placed adjacent to said unit, or integrated within it.

The invention also relates to an internal combustion engine exhaust line that includes the filtration device so described. This exhaust line includes at least one inlet for the gases produced by said internal combustion, at least one filtration device for trapping the solid particles contained in said exhaust gases from said engine and at least one atmospheric exhaust port for said gases located downstream from said filtration device. According to the invention:
the filtration device includes at least one catalysis means and means for the filtration of said exhaust gases within a reaction chamber located in the trajectory of the exhaust gas flow, said means comprising a plurality of filtering units, as previously described;
said line includes clacks or valves for insulating a part of the filtration device while stopping the exhaust gas flows reaching the part under consideration.

### BRIEF DESCRIPTION OF THE FIGURES

The present invention will be better understood from reading the following description, supported by the appended figures, which show, by no means restrictively, embodiment examples of the inventive filtration device and wherein:

FIG. 1 shows a three-dimensional diagrammatic view of the inventive device, including four filtering elements.

FIG. 2 shows a diagrammatic view in cross-section of these four elements assembled and bonded in a metal box.

FIGS. 3 and 4 show a three-dimensional diagrammatic view of these four elements assembled and bonded in the metal box illustrating a potential for welding.

FIGS. 5 and 6 show diagrammatically four filtering elements assembled and bonded in a metal box substantially different from the one shown in FIGS. 3 and 4, one part being in the form of a lid providing covering. FIG. 5 shows the way in which said box must be put under pressure before welding in order to ensure good compression of the ceramic mat so that a good seal can be guaranteed.

FIG. 7 shows in cross-section and in perspective respectively the use of filtering elements of triangular cross-section and the assembly thereof in a metal box.

FIG. 8 shows an inventive alternative with electrical heating resistances for heating each filtering element.

FIG. 9 shows the potential for providing at time of manufacture a channel in the honeycomb of the filtering elements so as to ensure better integration of the heating resistances.

FIG. 10 shows diagrammatically a filtration device using the inventive filtering elements, incorporating electrical resistances so that the regeneration phases can be controlled.

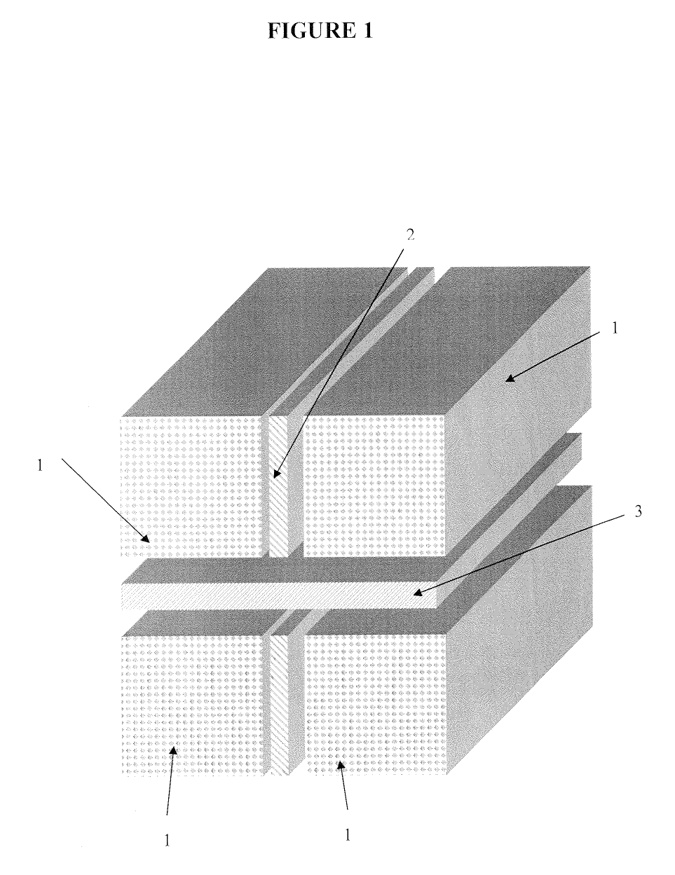

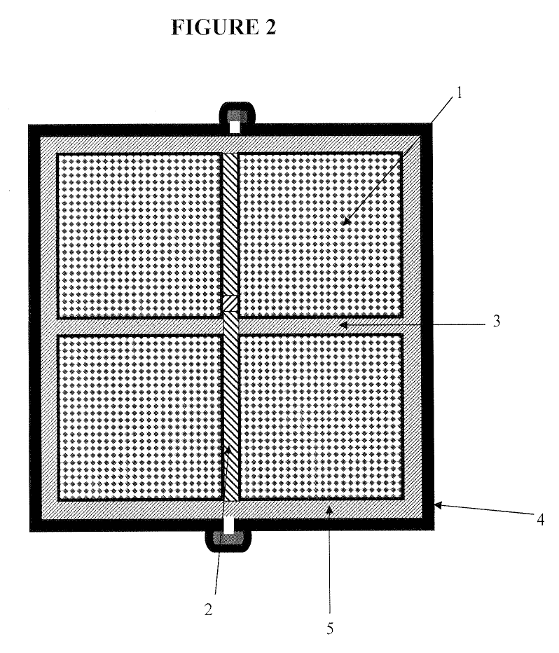

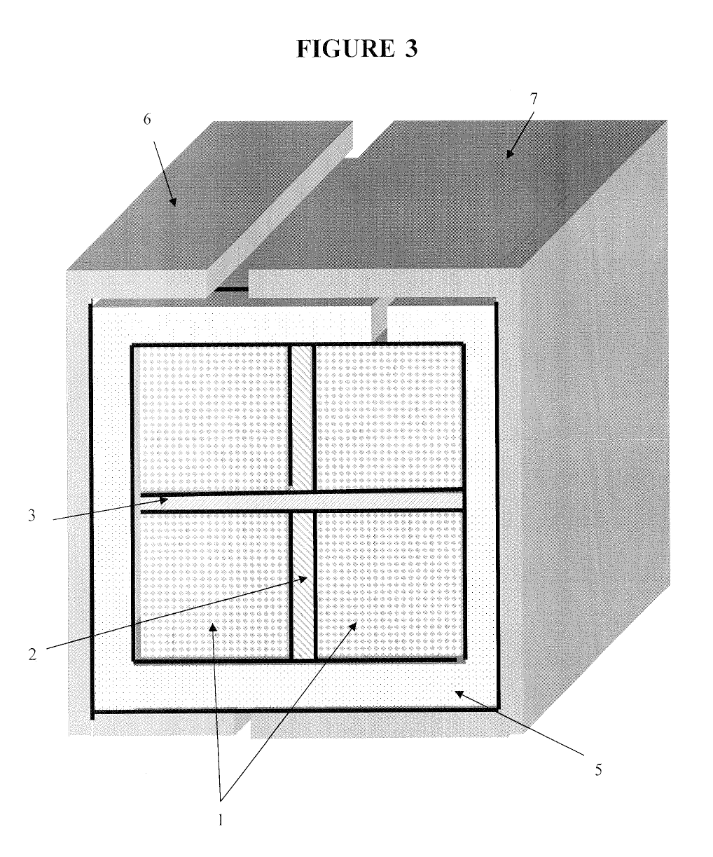

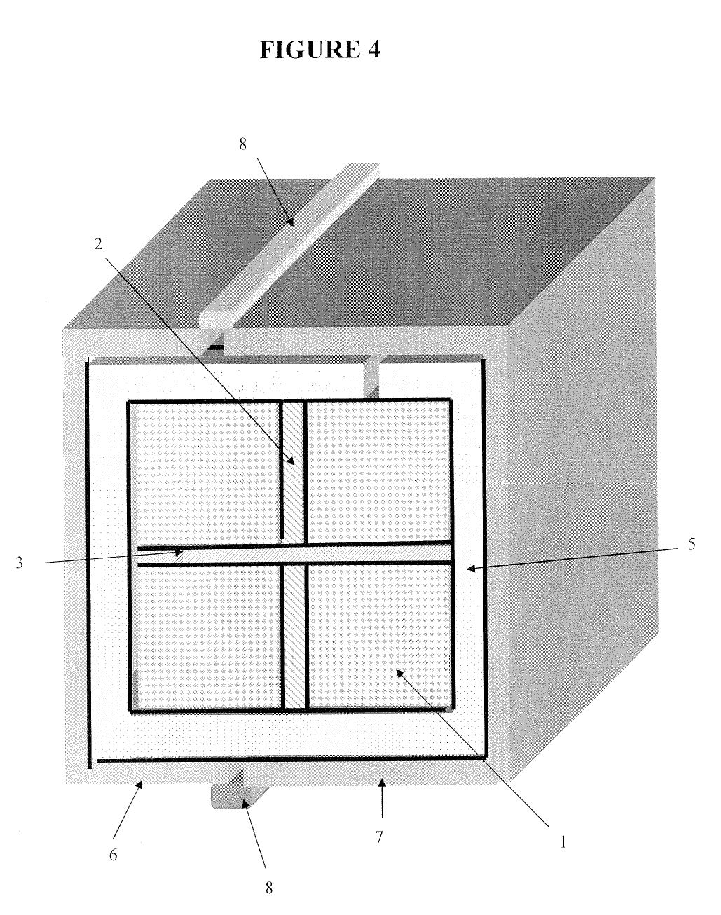

### INVENTIVE EMBODIMENT

According to a first inventive embodiment, the filtering units or elements (1) comprise a filtering medium made of cordierite, or of silicon carbide, or of some other ceramic adapted to the conditions, and particularly the thermal conditions, to which said elements may be subjected.

These filtering units (1) are presented in the shape of a parallelepiped with a honeycomb structure. In the example described, they are of square transverse cross-section, with a side dimension of between 20 and 200 millimetres, for lengths of between 50 and over 500 mm.

These filtering units are assembled in a rigid, preferably metal, holder (4), comprising in the case in point a box, by means of joints (5). It is this box which provides the mechanical cohesion of the assembled filtering units, these being further separated from each other by a joint (2, 3). These different joints offer significant thermal resistance and good compressibility, allowing the filtering units to expand during the regeneration phases. To advantage, these joints (5) comprise a cloth or mat made of ceramic, or any other flexible product offering good resistance at high temperature.

These joints (2, 3, 5) are coated on their two faces, in other words on both faces intended to come into contact with the two filtering units under consideration; by means of a ceramic glue, preferably based on oxides or ceramic carbides, (generally used for bonding brick or fireproof insulation felt of class 26 or above 1,400° C., which has a coefficient of expansion close to that of the filtering medium used), during assembly, to ensure bonding between their constituent cloth or mat and the filtering medium of the filtering units. They are typically between 0.5 and 15 mm thick.

Moreover, prior to their installation, the joints are impregnated with water, to keep them sufficiently moist, and to stop them from drying out the ceramic glue with which they are then coated, for example by brush. The glue must in fact remain in a malleable form throughout the process of implementing the filtering device.

Owing to this coating of glue, the mat is not therefore deeply impregnated by said glue, but restrictively in a superficial way, and typically in accordance with one or two thicknesses of its constituent long fibres. It is moreover for this reason that after assembly, the filtration units remain mechanically and thermally independent of each other.

Thus, for a mat with a thickness of about 2 mm, the thickness of the glue coating is in the vicinity of 2 tenths of a millimetre. The glue does not therefore penetrate inside the mat, with the result that it retains its mechanical and flexibility properties.

To advantage, the box (4) comprises a metal sheet preferably made of stainless steel, with the thickness thereof being adapted to the size of the assembly to be made, for example between 1 and 2 mm for a square assembly with sides of between 100 and 150 mm, or even more than 2 mm for boxes of larger dimensions. It is important for this box to have very good rigidity in order to keep the filtering units gathered together and to keep the mat separating them under pressure. The sole purpose of the glue which coats the surface between the mat and the filter is to ensure that the assembly is sealed.

To improve the rigidity of the metal sheet constituting the box (4), it is embossed. However, it may also be reinforced by welded reinforcements on its sides.

According to the invention, the box (4) comes as two parts (6) and (7), each of said parts partially surrounding four filtering units in the example described. These two parts are secured to one another by welding a linear rod (8) to their junction areas. Thus, for large sized boxes, this mode of assembly is facilitated, and may be automated.

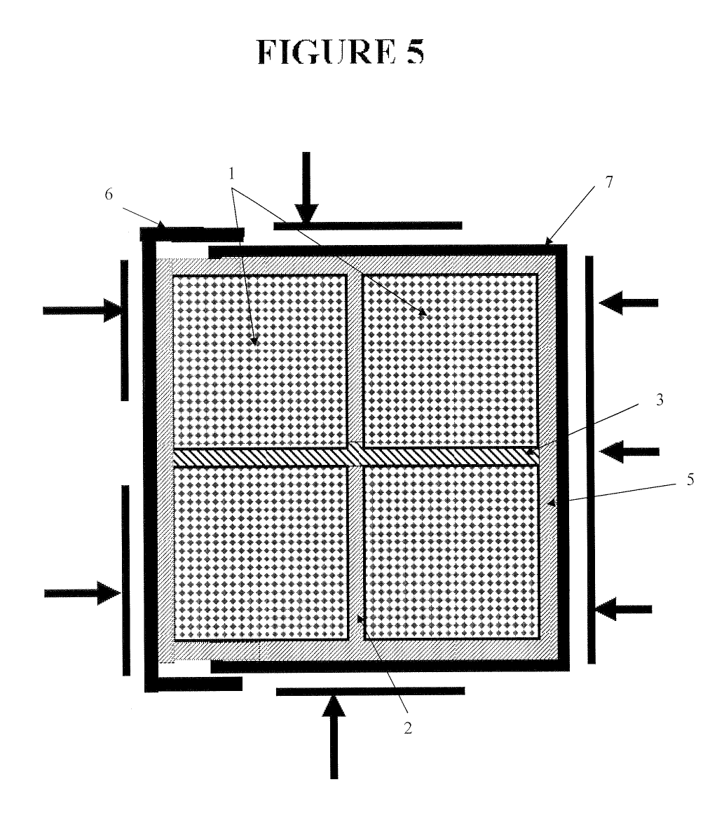

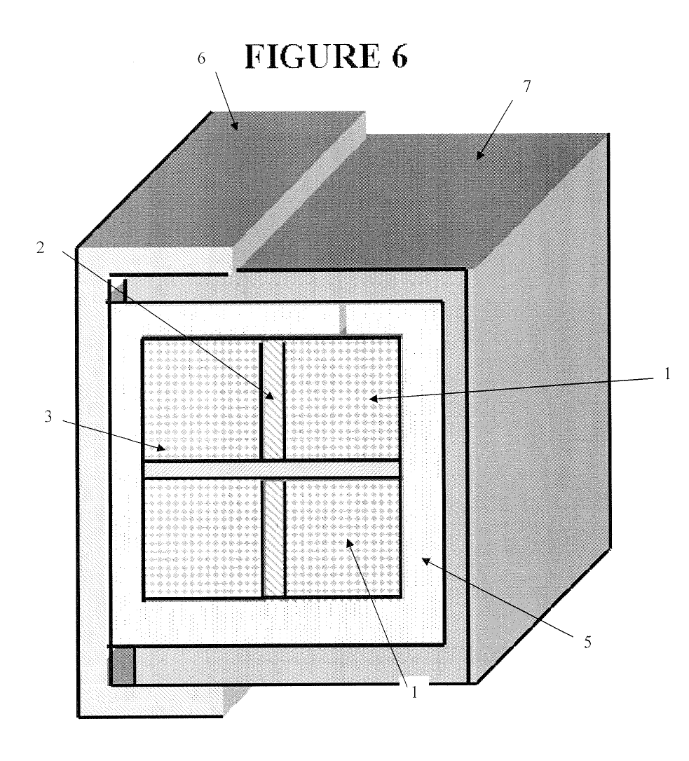

According to yet another alternative (see FIGS. 5 and 6), the two parts (6, 7) are embedded one in the other as a lid on a box. This alternative proves advantageous for small-sized boxes, typically with sides of up to 250 mm. In this case too, assembly production may be automated.

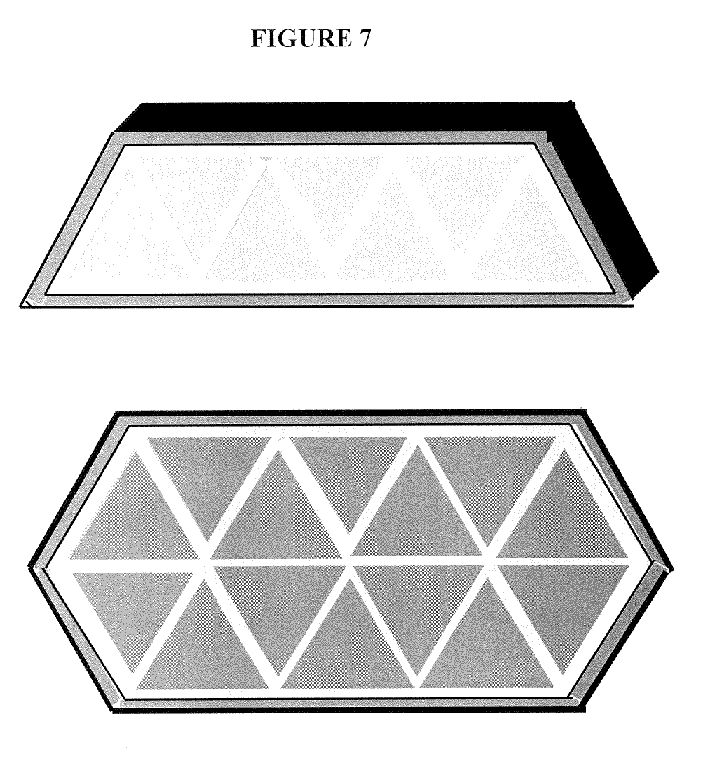

According to another inventive embodiment, the cross-section of the filtering units is no longer square in shape, but triangular in shape (see FIG. 7), the inventive principle remaining the same. This shape with a triangular cross-section favours the construction of extra-flat filters, typically with a height of less than 100 mm. Additionally, it allows filtering media to be used that have excellent resistance to very severe regenerations.

According to one advantageous inventive feature, an electrical heating resistance (8) is incorporated into the filtering units, intended in a known way to regenerate the filtering unit concerned.

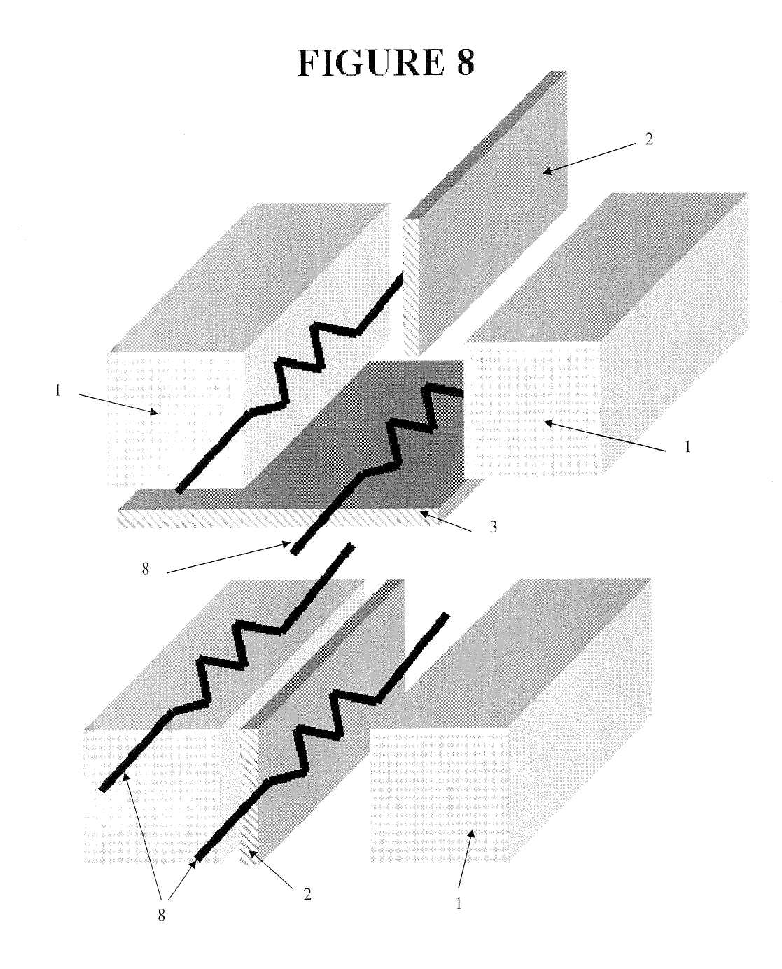

To this end, such heating resistances may be integrated during the assembly of the structure, on one of the faces thereof, as shown in FIG. 8, between the filtering medium and the ceramic mat, so as to be more or less secured to the filtering medium by the ceramic glue used in the assembly.

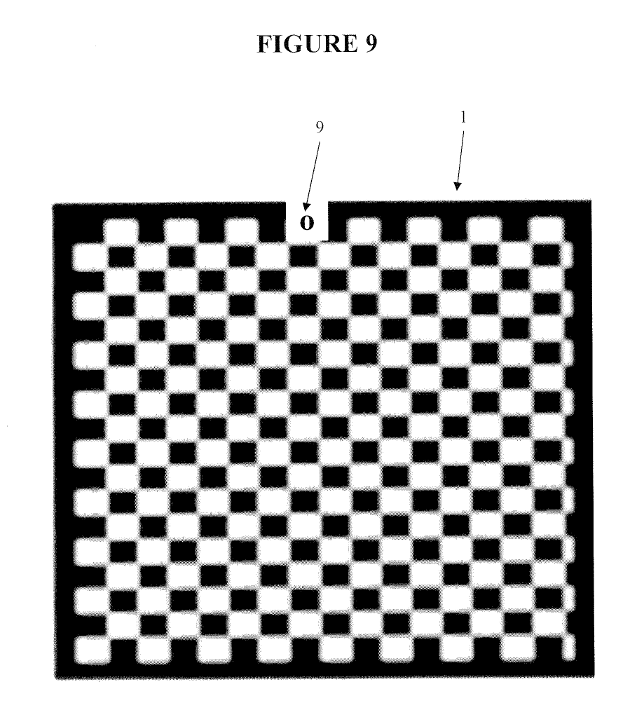

However, such heating resistances may also be integrated directly into said filtering medium, in one of the channels (9) defined by the honeycomb structure which characterizes them and reserved to this end as shown in FIG. 9.

The electrically heated filtering medium is used to advantage in a device that comprises a system of valves and clacks, allowing part of the filter to be isolated. Indeed if it is required to programme regenerations of said medium when the engine is running, it is necessary to use several kilowatts of electrical power simply to compensate for all the calories which would be carried away in the exhaust gases. For example for a 100 kW diesel engine operating at half-charge, the exhaust gas flow is in the vicinity of 100 g/s, requiring 20 kW of electrical power simply to raise the temperature of the exhaust gases by 200° C.

On the other hand, if by means of such a valve, only one of the filtering units is heated, for a mass of 1,000 grams, the electrical power needed to raise the temperature by 200° C. in 30 seconds drops to about 4 kW, or even to 2 kW if we can make do with achieving this result in one minute.

It is in fact conceivable to heat each filtering element individually one after the other in order to reduce if necessary the heating power.

When the regeneration temperature is reached (over 500° C. with no additive or 400° C. with additive), the valve that has kept the filtration unit concerned isolated from the exhaust gas flow, is gradually opened so as to bring the oxygen contained in the exhaust gases into contact with the carbon so that they can combust. The energy produced is then sufficient to bring all the elements in the unit well above the initial combustion temperature (500 or 400° C.) and to advance it to the whole filtration assembly.

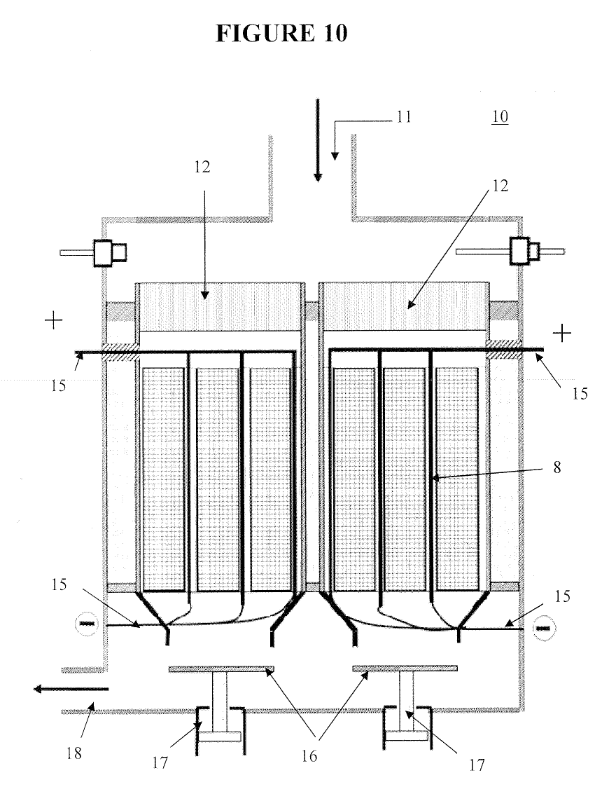

A representation has in fact been shown in relation to FIG. 10 of an exhaust line that incorporates a plurality of filtration units in accordance with the invention, and includes said electrical heating resistances.

The exhaust gases output by the engine are introduced into the device (10) via a pipe (11), and are then directed towards the catalyst elements (12), to be then filtered in two filtration structures (13, 14) containing the filtration units (1) in accordance with the invention. Each of the filtration units may be heated by means of heating resistances (8), associated with a corresponding electrical circuit (15).

According to the invention, the valves or clacks (16) are positioned at the output of the filtration structures, so as to be able to block off one or other of said structures, in order to keep the sealed structure at a high temperature, and favour the general operation of the exhaust line. These valves or clacks are activated by any means, such as for example air jacks (17).

The device (10) further comprises an outlet pipe (18) for the exhaust gases so filtered. Moreover, it comprises to advantage a temperature (19) and pressure (20) sensor, placed upstream of the filtration structures (13, 14), and intended to promote the operational management of the filtration units.

1. A filtration structure, comprising a plurality of filtering units including a filtering medium,
wherein said filtering units are separated from each other by a ceramic mat or cloth coated on two faces, intended to come into contact with said filtering units, with a ceramic glue, in order to secure the units to each other while keeping the units mechanically and thermally independent;
and wherein said filtering units are then inserted into a structure, and are secured to the structure by a holder made of a ceramic mat or cloth coated with a ceramic glue.

2. A filtration structure as claimed in claim 1, wherein the filtering units comprise a honeycomb structure made of ceramic.

3. A filtration structure as claimed in one claim 1, wherein the ceramic mat or cloth comprises long fibres, and has a density of between 150 and 500 kg/m³, and a thickness of between 0.5 and 10 mm.

4. A filtration structure as claimed in one claim 1, wherein the ceramic mat or cloth is pre-impregnated with water before being coated with glue on the faces.

5. A filtration structure as claimed in claim 1, wherein the filtering units have a shape of a parallelepiped of square transverse cross-section.

6. A filtration structure as claimed in claim 5, wherein a dimension of sides of the square transverse cross-section is between 20 and 200 millimetres, and a length of the filtration units is between 50 and 500 mm.

7. A filtration structure as claimed in claim 1, wherein the filtering units have a triangular transverse cross-section.

8. A filtration structure as claimed in claim 1, wherein the structure is made in two parts, secured one to the other by welding.

9. A filtration structure as claimed in claim 1, wherein the structure is made in two parts, one being embedded in the other.

10. A filtration structure as claimed in claim 1, wherein the filtering units are each associated with an electrical heating resistance, placed adjacent to a unit, or integrated within the unit.

11. An exhaust gas filtration device including at least one catalysis means and exhaust gas filtration means within a reaction chamber located in a trajectory of an exhaust gas flow, wherein the filtration means comprise a filtration structure as claimed in claim 1.

12. An internal combustion engine exhaust line, including at least one inlet for gases produced by internal combustion, at least one filtration device for trapping solid particles contained in exhaust gases of said engine and at least one atmospheric exhaust port for said gases located downstream from said filtration device,
wherein the filtration device includes at least one catalysis means and filtration means for filtration of said exhaust gases within a reaction chamber located in a trajectory of exhaust gas flow, said filtration means comprising a plurality of filtering units including a filtering medium, said units being separated from each other by a ceramic mat or cloth coated on two faces, intended to come into contact with said filtering units, with a ceramic glue, in order to secure the units to each other while keeping the units mechanically and thermally independent, and the units are inserted into a structure, and secured to the structure by a holder made of a ceramic mat or cloth coated with a ceramic glue, the filtering units being additionally each associated with an electrical heating resistance, placed adjacent to a unit, or integrated within the unit;
and wherein said line includes clacks or valves to isolate a part of the filtration device by stopping the exhaust gas flows reaching the part.

13. A filtration structure as claimed in claim 1, wherein said structure comprises a metallic or ceramic structure.

14. A filtration structure as claimed in claim 2, wherein said ceramic comprises cordierite or silicon carbide.

15. An internal combustion engine exhaust line as claimed in claim 12, wherein the structure comprises a metallic or ceramic structure.
